(19) United States
(12) Patent Application Publication
(10) Pub. No.: US 2026/0370727 A1
(43) Pub. Date: Nov. 19, 2026

(54) METHOD FOR DETERMINING A GROUP OF SERVERS

(71) Applicant: ORANGE, ISSY LES MOULINEAUX (FR)

(72) Inventors: Bruno CHATRAS, Chatillon (FR); Roland PICARD, Chatillon (FR)

(21) Appl. No.: 19/153,755

(22) PCT Filed: Jan. 29, 2024
(86) PCT No.: PCT/EP2024/052017

§ 371 Date: Aug. 5, 2025

(30) Foreign Application Priority Data
Feb. 6, 2023 (FR) FR2301072

(51) Int. Cl. H04L 67/00; H04L 41/122

(52) U.S. Cl. CPC H04L 67/34; H04L 41/122

(57) ABSTRACT

A method for determining a group of computer servers of a virtualized communication network, the group being able to host a software component contributing to provision of a service in the network. The software component requires implementation of an associated software function for processing a service datum. The method is implemented in an orchestration entity and includes: transmitting a request to deploy the software component to a management entity managing the software component, the request including an identifier of the software component and at least one parameter of the associated software function; obtaining a characteristic of a programmable device suitable for receiving the associated software function, determined on the basis of the at least one parameter; and determining the group of servers, which includes at least a first server suitable for receiving the software component and a second server including the programmable device compatible with the obtained characteristic.

### TECHNICAL FIELD

The present disclosure relates to the field of communication networks implemented on the basis of virtualized functions, i.e. on the basis of instantiated software on standard computer servers. The invention aims more precisely to enable the automatic deployment of such virtualized functions requiring hardware or software acceleration functions by identifying a zone or a cluster comprising at least one server capable of hosting a virtualized function, but also at least one server capable of implementing an acceleration function.

### PRIOR ART

Network function virtualization (NFV) has become a basic trend in the telecommunications industry. Fifth-generation mobile networks are thus natively designed as sets of virtualized network functions, and it is recognized that this will be the same for the sixth generation and also the following generations. In this case, network functions are delivered in the form of an archive file known as a VNF (Virtualized Network Function) package containing, in particular, software to be installed and also one or more files containing the information necessary for the installation of the software in an NFV infrastructure and for the management of the life cycle of the network function by so-called management and orchestration (MANO) functions. In some cases, this software is deployed in virtual machines and/or in containers.

An NFV architecture comprises the use of standard computer servers, referred to as “off-the-shelf” servers, to host the software of the network functions, as opposed to specialized equipment. These servers are equipped with processors which are themselves standard processors (general-purpose processors as opposed to processors that are specialized or dedicated to one function), such as processors based on the Intel x86 architecture. Although these processors, particularly in the case of a so-called multicore configuration, are capable of achieving high performance, this performance remains insufficient in some cases, for example when the volume of traffic to be processed is very high and/or the latency constraints are very severe.

This applies in particular to network functions operating directly on the data flows exchanged between the equipments of the users connected to the network or between these equipments and application or content servers. These network functions are generally referred to as belonging to the data plane or user plane. The prime example in 5G core networks is the UPF (User Plane Function).

For this type of network function, manufacturers employ software or hardware acceleration solutions in addition to the virtualized network function deployed on a standard server. A family of solutions, known as “hardware offload” solutions, consists in relieving the main processor of the server hosting the VNF of certain processing tasks, which are then transferred to an auxiliary processor which is installed, for example, on a network card or a specialized card added to this server, or remote equipment accessible via the infrastructure network. The auxiliary processors concerned can be specialized or programmable.

Existing specifications do not enable determination of how a software image to be installed on a programmable accelerator and offering the associated software function, such as an accelerator, is identified in a VNFD descriptive file (element of the VNF package described above), nor how such information can be transmitted and taken into account by managers of a virtualized architecture to enable total automation of the process of installing an accelerated VNF in an NFV infrastructure.

### SUMMARY OF THE INVENTION

The object of the present disclosure is to overcome all or some of the limitations of the solutions from the prior art, in particular those described above, by proposing a solution which enables automatic deployment of a virtualized function requiring an associated software function, for example acceleration of a flow or a datum, suitable for the virtualized function.

For this purpose, a method is proposed for determining a group of computer servers of a virtualized communication network, said group being capable of hosting a software component contributing to the provision of a service in said network, said software component requiring the implementation of an associated software function for processing a service datum, said method being implemented in an orchestration entity and comprising:
transmitting a request to deploy the software component to a management entity managing the software component, said request comprising an identifier of the software component and at least one parameter of the associated software function,
obtaining a characteristic of a programmable device suitable for hosting the associated software function, determined on the basis of the at least one parameter,
determining said group of servers, comprising at least a first server suitable for hosting the software component and a second server comprising said programmable device compatible with said obtained characteristic.
   The determination method provides assurance that a software component, such as software comprising instructions relating to a virtualized function, can be deployed in a group of servers, which can correspond to a zone or cluster, further comprising a programmable device on which a software function associated with this software component can be installed. If the associated software function performs a function enabling the software component to be relieved of certain processing tasks, for example processing tasks which are onerous in terms of performance and/or processing capacity, it will thus be possible to perform an update of the communication network comprising the deployment of a new software component, guaranteeing that this software component can in fact benefit from optimized capacities implemented by the associated software function. The consideration of one or more parameters relating to the programmable device capable of hosting the software function in a manner correlated with the request to deploy the software component ensures that the choice that will be made to determine a server, zone or cluster to host a software component will be made by taking account, in the choosing process, of the availability of a server comprising the programmable device in close proximity or even on the same server on which the software component is installed. The performance of the software component assisted for certain processing tasks by the associated software function will thus be ensured, and the quality of the service using the software component will be guaranteed. This determination method is therefore highly advantageous compared with the prior art, since a server, zone or cluster will be selected only if a server of the zone or of the cluster further comprises a programmable device compatible with the software function or, more precisely, with one or more parameters of the software function.

This method further enables the different servers, and even the software components and software functions, to be heterogeneous and, for example, to originate from different manufacturers. In fact, the characteristics of the programmable device required for the installation of the software function are, for example, described in a description document and any server comprising a programmable device compatible with one or more parameters of the associated software function, and therefore compatible with the software component, can be selected. The method further highlights the possibilities for updating the virtualized communication network, since a constraint that might have existed previously, i.e. to have a guarantee of providing a software function associated with a software component, is now eliminated by the determination method. A parameter of the associated software function can, for example, correspond to a program written in a specialized language (Domain Specific Language, DSL), for example P4, independent of any execution target, or one or more executables resulting from the compilation of the program toward one or more execution targets of the programmable device. The parameter can further correspond to an identifier of the associated software function, or a link (or pointer) pointing to an executable allowing the actual deployment of the associated software function, dispensing with the transmission of the executable. The associated software function can, for example, be present in the VNF package. The identifier of the software component and at least one parameter of the associated software function can advantageously be included in a descriptive document, for example of the VNFD type, comprising, for example, VNFC and/or VNF identifiers as well as programs or executables associated with the VNFC components and/or with the VNF.

A plurality of software functions may be required for one or more software components. In this case, the determination method can advantageously comprise parameters enabling determination of one or more servers suitable for hosting software functions. Furthermore, two different software functions can also be hosted on the same server, for example if the parameter characterizing the programmable hosting device is identical for these two software functions. In one particular case, the first and the second server can correspond to virtual servers and can possibly be deployed on the same physical server. A virtualized communication network is considered in its broadest sense. It can thus be considered that the virtualized communication network is established through the deployment and configuration of software functions on physical servers in accordance with requests and instructions transmitted by various administration entities commonly referred to as MANO (Management and Orchestration) functions in an NFV environment.

A plurality of virtualized communication networks can thus be established on a virtualized infrastructure, and the updating of this infrastructure in line with the requirements of a communication network is considered to correspond to an update of a communication network. The operators providing the management of the communication networks and the operators providing the management of the virtualized infrastructure on which the communication networks are implemented can be different. The determination of a zone within the virtualized communication network can thus correspond to a determination of a zone within an execution infrastructure comprising, in particular, a virtualized infrastructure and (MANO) administration entities of the virtualized infrastructure implemented on generic physical servers. A software component deployed on such a server, and also the associated software function, thus enable the updating of the execution infrastructure and therefore of a communication network established on this infrastructure.

According to one aspect of the invention, in the method for determining a group of servers, obtaining a characteristic comprises receiving an authorization request from the software component management entity to deploy the software component.

Obtaining the characteristic of a programmable device suitable for hosting the associated software function can advantageously be linked with or included in an authorization request to deploy the software component in order to be able to ensure that the software component will be deployed with a guarantee of the availability of the associated software function.

According to a different aspect, the method for determining a group of servers further comprises reserving a resource of the second server comprising said programmable device.

According to this embodiment, the method further allows the reservation of capacities, i.e. a resource of the second server on which the associated software function will be installed, thus ensuring that, when the software component is installed, the software function, or the executable of the associated software function, can in fact be installed.

According to a different aspect, the method for determining a group of servers further comprises deploying, by means of a management entity of the virtualized communication network, the software function on said programmable device of the second server of which a resource has been reserved.

The software function can advantageously be installed on or downloaded onto the programmable device determined by the orchestration entity by means of an entity responsible for the resources of the virtualized network, such as a VIM (Virtual Infrastructure Manager) entity. The reserved resource is thus allocated with certainty to the software function, and the software component, such as a VNF (VNFC) component, can use it as soon as said component is downloaded onto a server of the cluster or zone.

According to a different aspect, the method for determining a group of servers further comprises creating a group of servers comprising at least one server suitable for hosting the software component, and a server comprising said programmable device compatible with said characteristic.

If the determination step has not identified any cluster or zone comprising the servers required for the instantiation of the software component and the software function associated with the software component, the method can advantageously comprise creating a cluster of this type comprising at least the two required servers in such a way that the component and the associated software function can be downloaded in accordance with the parameter and therefore with the obtained characteristic. This creation can be implemented by means of a management entity of the virtualized communication network such as a CCM (CIS (Container Infrastructure Service) Cluster Management) entity which can itself be based on a VIM entity in the case of a cluster based on virtual servers, or a PIM (Physical Infrastructure Manager) entity in the case of physical servers (e.g. OpenStack Ironic). The CCM is thus responsible for creating the cluster and, in the case of a cluster on virtual servers, it uses the VIM. In the case of a physical cluster (container on bare metal), it uses a PIM (Physical Infrastructure Manager (e.g. OpenStack Ironic)).

According to a different aspect, in the method for determining a group of servers, at least one characteristic of a programmable device is included in the characteristics of the following group:
a memory space size of the programmable device,
a number of processing units of the programmable device,
a type of programmable device,
an identifier of the programmable device,
an address for downloading the software function onto the programmable device.

The characteristic of the programmable device used to select or create a server can correspond to one or more characteristics from the following. It can thus comprise so-called hardware capacities corresponding to a required number of CPUs (Central Processing Units), a virtual memory size or virtual disk size. It can also comprise the type of programmable device to be used, for example an FPGA (Field-Programmable Gate Array) or eBPF (Extended Berkeley Packet Filter). It can also comprise an identifier of the programmable device comprising one or more data from the following: name of the supplier of the programmable device, name of the programmable device, server supporting the programmable device, version of the programmable device, type of programmable device (hardware or software). The parameter can also comprise an address for downloading the software function or a pointer to a program to be loaded onto the programmable device. A plurality of programmable devices can possibly host a software function associated with a software component, and the characteristic can correspond to one or more programmable devices compatible with the transmitted parameters. The method thus enables the selection of a server comprising a suitable programmable device, from the compatible devices, for a software function or for a set of software functions based on the parameters of the associated software function included, for example, in the description document.

According to a different aspect, in the method for determining a group of servers, the software function is an acceleration function for processing the data flow.

The method can advantageously be carried out for a software function corresponding to an acceleration function for the processing of certain data flows, thus relieving the software function of certain onerous tasks in terms of resources for the virtual server hosting the software component.

According to a different aspect, the method for determining a group of servers further comprises transmitting, to a management entity of the virtualized network, a computer program of the associated software function intended to update the programmable device of the second server.

According to a different aspect, in the method for determining a group of servers, the deployment request comprises transmitting a document comprising the identifier of the software component and the at least one parameter of the associated software function, said document further comprising a reference to the associated software function and a reference to a computer program, on the basis of which the associated software function is made compatible with the programmable device.

The deployment request can advantageously comprise a description document. This document can correspond, for example, to a VNFD document, for example included in a VNF package comprising, in particular, references to an executable to be installed on a programmable device and also possibly an indication of the type of device and its version, a computer program, for example written in a specific language, on the basis of which an executable compatible with a programmable device is generated, or possibly a set of executables corresponding to the same program with an indication for each one of the type of programmable device and its version.

The different aspects of the method for determining a group of servers that have just been described can be implemented independently of one another or in combination with one another.

The invention also relates to a method for determining a programmable device capable of hosting a software function associated with a software component contributing to the provision of a service in a virtualized communication network, said programmable device being implemented in a server of the network, the method carried out in a management entity of the software component comprising:
receiving, from an orchestration entity, a request to deploy the software component, said request comprising an identifier of the software component and at least one parameter of the associated software function,
determining a characteristic of the programmable device suitable for hosting the associated software function on the basis of the at least one parameter received in the deployment request.

According to one aspect, the method for determining a programmable device further comprises transmitting an authorization request to the orchestration entity to deploy the software component comprising the determined characteristic.

According to a different aspect, the method for determining a programmable device further comprises, prior to the determination step, transmitting a request for a document describing the software component and receiving said document.

According to a different aspect, the method for determining a programmable device further comprises receiving a message requesting the installation of the software component on a first server of a determined group of servers and the installation of the software function on a programmable device comprised in a second server of the group of servers, said programmable device being compatible with said determined characteristic.

According to one aspect, the method for determining a programmable device further comprises transmitting a message requesting the deployment of the software component on the first server of said group.

If the software component, which may correspond to a VNF (VNFC) component or to a VNF, the method comprises, according to one embodiment, instantiating the software component on the first server determined by an orchestration entity. This downloading of the software component can be carried out independently of or jointly with the downloading of the software function associated with the software component. This instantiation can be performed by means of the management entity of the software component and possibly also by means of a management entity of the virtualized communication network. The virtualized communication network is thus updated and becomes operational to provide the service using the software component.

The different aspects of the method for determining a programmable device that have just been described can be implemented independently of one another or in combination with one another.

The invention also relates to a device for determining a group of computer servers of a virtualized communication network, said group being capable of hosting a software component contributing to the provision of a service in said network, said software component requiring the implementation of an associated software function for processing a service datum, said device for determining a group of computer servers of a virtualized communication network being configured to:
transmit a request to a management entity of the software component to deploy the software component, said request comprising an identifier of the software component and at least one parameter of the associated software function,
obtain a characteristic of a programmable device suitable for hosting the associated software function, determined on the basis of the at least one parameter,
determine said group of servers comprising at least a first server suitable for hosting the software component, and a second server comprising said programmable device compatible with said obtained characteristic.

This device for determining a group of computer servers is capable, in all its embodiments, of carrying out the method for determining a group of servers that has just been described.

The invention also relates to a device for determining a programmable device capable of hosting a software function associated with a software component contributing to the provision of a service in a virtualized communication network, said programmable device being implemented in a server of the network, said device for determining a programmable device being configured to:
receive a request from an orchestration entity to deploy the software component, said request for an identifier of the software component comprising an identifier of the software component and at least one parameter of the associated software function,
determine a characteristic of the programmable device suitable for hosting the associated software function on the basis of the at least one parameter received in the deployment request.

This device for determining a programmable device is capable, in all its embodiments, of carrying out the method for determining a programmable device that has just been described.

The invention also relates to a system for determining a group of computer servers of a virtualized communication network, said group being capable of hosting a software component contributing to the provision of a service in said network, said software component requiring the implementation of an associated software function for processing a service datum, said system comprising:
a device for determining a group of servers described above,
a device for determining a programmable device also described above.

The invention also relates to computer program products comprising a set of program code instructions which, when they are executed by at least one processor, configure said at least one processor to carry out the respective methods for determining a group of servers and a programmable device according to any one of the embodiments of the present disclosure.

The invention also relates to a computer-readable recording medium on which a set of program code instructions is recorded which, when they are executed by at least one processor, configure said at least one processor to carry out a method for determining a group of servers or a method for determining a programmable device according to any one of the embodiments of the present disclosure.

### BRIEF DESCRIPTION OF THE DRAWINGS

The invention will be better understood from reading of the following description, given by way of example and in no way limiting, and provided with reference to the figures, in which:

FIG. 1 shows a schematic representation of a communication network composed of virtualized functions,

FIG. 2 shows a schematic representation of a method for determining a group of servers carried out in an NFV architecture,

FIG. 3 shows a diagram illustrating the main steps of a method for determining a group of servers according to a first embodiment,

FIG. 4 shows a diagram illustrating the main steps of a method for determining a group of servers according to a second embodiment,

FIG. 5 shows a representation of a device for determining a group of servers according to one example,

FIG. 6 shows a device for determining a programmable device according to a different example.

In these figures, identical references from one figure to another denote identical or similar elements. In the interests of clarity, the elements shown are not drawn to scale, unless otherwise stated.

### DESCRIPTION OF THE EMBODIMENTS

More generally, it should be noted that the embodiments considered above have been described as non-limiting examples, and that other variants are consequently conceivable.

The description below presents embodiments of the invention in a virtualized communication network, which can comprise, for example, one or more access networks and one or more core networks. This virtualized communication network can be implemented to route communication data to fixed or mobile terminals, and the network can be implemented with/by virtualized functions, although non-virtualized functions can also be included in the mainly virtualized network, for example by using specific equipment for a given function. This network can be used to route and/or process data from residential or business customers.

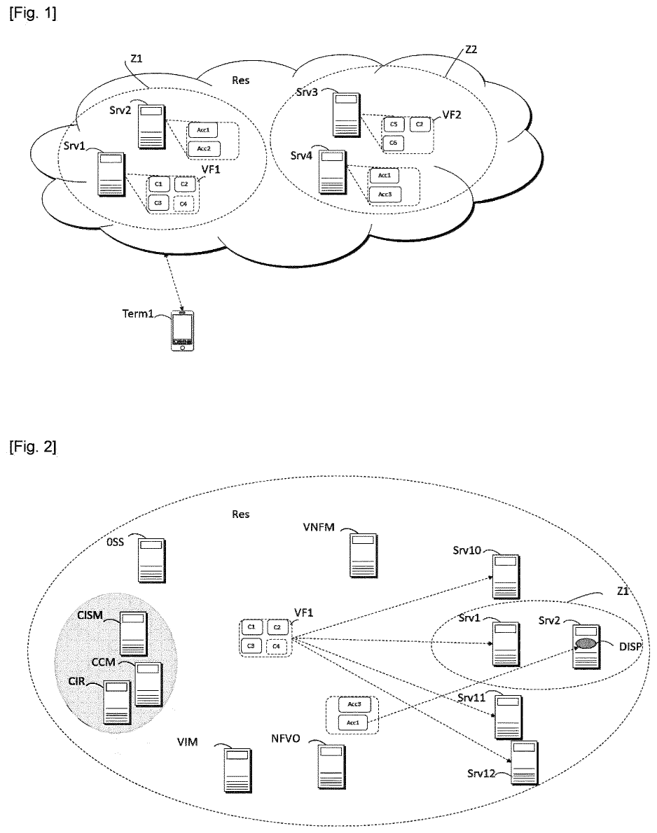

Reference is first made to FIG. 1 which shows a schematic representation of a virtualized communication network Res made up of virtualized functions.

This communication network Res is made up of two zones Z1 and Z2, also referred to as clusters, which can, for example, be geographical zones. The network can comprise a larger number of zones, the number 2 having been chosen so that the figure is legible. Each zone Z1 and Z2, according to the example given, is made up of 2 servers, namely Srv1 and Srv2 for the zone Z1, and the two servers Srv3 and Srv4 in the zone Z2. The servers Srv1 and Srv3 are, for example, standard computer servers, known as “off-the-shelf” servers, to host the software of the virtualized functions of VF1 and VF2, as opposed to specialized equipment. These servers are equipped with processors which are themselves standard processors (general-purpose processors as opposed to processors that are specialized or dedicated to one function), such as processors based on the Intel x86 architecture. The servers Srv2 and Srv4 are, for example, also standard computer servers, implemented to host software functions such as acceleration functions Acc1, Acc2 and Acc3.
A virtualized function VF1 is installed on the server Srv1 of the zone Z1. This virtualized function VF1 performs a function of routing and/or processing data transmitted or received by the terminal Term1. According to some non-limiting examples, this virtualized function VF1 can be a function of a user plane of a mobile communication network, a function of a control plane of a mobile communication network, a function of a management plane of a mobile communication network, or even equivalent functions of a fixed communication network, or else an application processing function associated, for example, with a communication service.

The virtualized functions VF1 and VF2 can be made up of one or more components, each providing an elementary processing of the function VF1 or VF2. According to the example described in FIG. 1, the virtualized function VF1 is made up of four components C1, C2, C3 and C4 and the virtualized function VF2 is made up of 3 components C2, C5, C6. According to a different example which is not shown, a virtualized function can comprise a single component, this component being identified with the identifier of the virtualized function and/or of the component.

The virtualized functions VF1 and VF2, and therefore their associated components, can be instantiated on virtual machines or containers according to the virtualization technology used, based on a hardware virtualization for the virtual machines, and an operating system virtualization for the containers.

The virtual functions VF1 and VF2, and, more particularly, the respective components C2, C3 and C5 of these virtual functions VF1 and VF2, require software functions to perform certain processing tasks with greater efficiency than if the components alone performed these processing tasks. This applies particularly in the case of certain components of the network functions operating directly on the data flows exchanged between the equipments of the users connected to the network Res or between these user equipments and application or content servers. These network functions are generally referred to as belonging to the data plane or user plane. The prime example in 5G core networks is the UPF (User Plane Function). The components operating in the data plane possibly require software functions to improve the processing of the data (Acc1, Acc2, Acc3 in FIG. 1).

Manufacturers employ software or hardware acceleration solutions in order to deploy these software functions Acc1, Acc2 and Acc3. A family of solutions, known as “hardware offload” solutions, consists in relieving the main processor of the server hosting the VNF of certain processing tasks, which are then transferred to an auxiliary processor which is installed, for example, on a network card or a specialized card added to this same server (alternative not shown in FIG. 1), or a remote server (Srv2 for Srv1, or Srv3 for Srv4 in FIG. 1), given that the remote server can be accessible, for example, via a communication infrastructure when this is possible (not shown in FIG. 1). The auxiliary processors concerned can be specialized or programmable, such as programmable logic circuits such as FPGAs (Field-Programmable Gate Arrays). One example of a programming language suitable for packet processing (DSL, Domain Specific Language) is the language P4 (Programming Protocol-Independent Packet Processor). As with any non-interpreted language, a program written in P4 needs to be compiled in order to be translated into a machine language comprehensible to the hardware on which it must be executed.

A virtualized function VF1 and VF2 and, more precisely, the elementary components C1, C2, . . . , C6 which make up these virtualized functions VF1 and VF2, can be instantiated dynamically in the communication network Res to meet a new service requirement, to improve performance or to adapt the network to a new context. Given that some virtualized functions or some components further require an associated software function, the deployment of a new component requires consideration of the implementation of a new software function or the programming of a programmable device with a software function required for the new installed component. The choice of the zone Z1 or Z2 for deploying, according to one example, a new software component C2 will be made depending on the possibility of actually being able to update a programmable device with the required software function Acc1 on a server in said zone. According to one example, purely by way of illustration and without limitation, the associated software function corresponds to an executable computer program that performs an acceleration function and is to be loaded onto a programmable device which can correspond to a programmable accelerator.

Reference is now made to FIG. 2, which shows a schematic view of a determination method carried out in an NFV (Network Function Virtualization) architecture. Within this architecture, an NFVO (Network Function Virtualization Orchestrator) entity is responsible for the life cycle of the services instantiated on the basis of one or more virtualized functions, including the virtualized function VF1. The OSS (Operations Support Systems) entity manages the communication network (Res in FIG. 1), in particular deployed on the basis of an NFV architecture, and uses the NFVO entity for this purpose. The VNFM (Virtualized Network Function Manager) entity is responsible for the management and life cycle of a virtualized function such as the function VF1. The VIM (Virtualized Infrastructure Manager) entity manages the resources of an NFV infrastructure (NFVI, Network Function Virtualization Infrastructure), on which a virtualized function such as VF1 is deployed. The virtualized function VF1 is possibly made up of a plurality of software components, also referred to as elementary components, each of these components carrying out the implementation of one or more processing tasks for processing a datum or data flow.

If the communication network is based on a containerization technology, CISM (Container Infrastructure Service Management), CCM (Container Cluster Management) and CIR (Container Image Repository) entities can further contribute to the deployment and updating of the virtualized infrastructure. The CISM manages the containers and the container infrastructure, while the CCM manages the clusters, consisting of groups of machines that can execute containerized applications. The CIR comprises images to be installed in containers and a set of images used to provide different versions of an application.

When a new virtualized function needs to be deployed, for example following a request sent by the OSS entity, or a virtualized function needs to be updated, for example by adding a new software component, an NFVO entity must decide on the zone, for example represented by a cluster, in which the component needs to be instantiated. This decision can be made depending on a service, on the position of a different software component or physical equipment, but if the virtualized function or the software component further requires an associated software function, for example an acceleration function, the decision then takes account of the presence in the zone or cluster of a programmable device hosted by a server and suitable for being programmed to perform the software function associated with the software component.

From the four possible options (Srv1, Srv10, Srv11, Srv12) for hosting the virtualized function VF1 or the component C1 if only the component C1 is required, the server Srv1 is selected since it is in a zone Z1 further comprising a server Srv2, this server Srv2 comprising a programmable device DISP to which the software function Acc1 associated with the function VF1 (or with the component C1) can be added, thus enabling optimum performance of the virtualized function by benefiting from the advanced processing functions permitted by said associated software function Acc1, which would not have been the case if one of the other servers Srv10, Srv11, Srv12 had been selected. This selection made by the NFVO entity, in conjunction with the VNFM entity, is based on the specification of the associated software application, via one or more parameters, and on the determination of the programmable device by the VNFM entity based on the specification of the associated software function. Once the programmable device has been characterized, it is appropriate to identify a zone or cluster, i.e. a group of servers, comprising a server suitable for hosting the software component, such as the virtualized function, and further comprising a server comprising the characterized programmable device. It should be noted that, according to one example, the server hosting the software component and the server comprising the programmable device can be the same server. The NFVO entity thus determines the zone Z1 in which the virtualized function VF1, and then a VIM and/or CISM entity determines, in the zone Z1, the server most capable of hosting the software component, i.e. in this case the server Srv1, present in the same cluster as the server Srv2 comprising the programmable device.

The NFVO entity, interacting with the VIM entity, can further reserve the resources on the server Srv1 to install the software component, and possibly resources on the Srv2 to install the software function associated with the software component and compatible with the programmable device of the server Srv2.

The VNFM entity then interacts with the VIM entity, and possibly with the CISM or CCM and CIR entities if the servers use containerization technology, to carry out the actual deployments in the virtualized network, these allocated resources possibly being communicated to the VIM entity in this case.

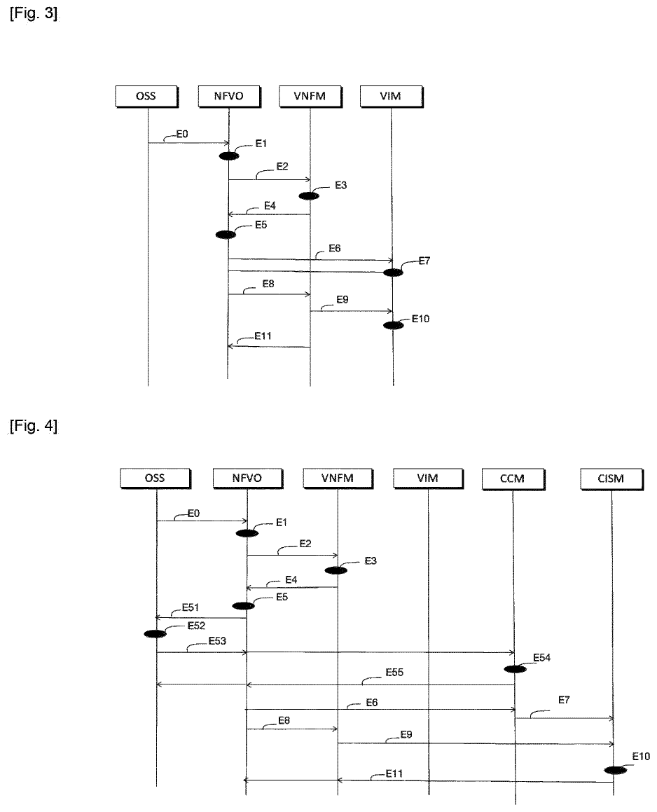

Reference is now made to FIG. 3 which shows a diagram illustrating the main steps of a method for determining a group of servers according to a first embodiment. In this embodiment, the virtualization technology is based on virtual machines. In this embodiment, the servers as shown in the preceding figures are equipped with virtual machines suitable for hosting software components and software functions. For the sake of understanding, this figure is deliberately simplified compared with NFV MANO (Network Function Virtualization (NFV) Management and Orchestration) architecture.

In a step E0, an OSS entity requests, from an NFVO entity, corresponding to an orchestration entity, the deployment of a new service requiring the implementation of one or more virtualized functions in the communication network, of which one or more, required for the service, may already be present in the virtualized infrastructure (NFVI) of the communication network. This request comprises, for example, an identifier of an NSD (Network Service Descriptor) file and, according to a different example, the NSD file. This file comprises, for example, information relating to the virtualized functions, for example VNFDs (Virtualized Network Function Descriptors) and non-virtualized functions, for example PNFDs (Physical Network Function Descriptors), required for the deployment of the service, as well as information relating to the links between these functions. According to one example, prior to this step E0, in steps that are not shown, the OSS retrieves a VNF package comprising the NSD file from a VNF provider and the OSS transmits the VNF package to the NFVO entity.

In a step E1, the NFVO analyzes the NSD description and determines the type of virtualized function and the number of instances of this virtualized function to be implemented in the communication network, as well as the virtual links to be established between these virtualized functions. According to one example, a plurality of virtualized functions and a plurality of instances of one or more virtualized functions can be determined.

In a step E2, the NFVO sends at least one request to a VNFM, corresponding to a management entity of a software component, to deploy a virtualized function instance, as determined in step E1. To make the figure sufficiently clear, a single VNFM is shown, but the NFVO can request a plurality of VNFMs, particularly if different VNFMs manage specific virtualized functions. The request to deploy the software component, i.e. the virtualized function or an elementary component of a virtualized function, includes the reference, for example an identifier relating to a document describing the required software component or the document itself, such as a VNFD (Virtualized Network Function Descriptor) document comprising, in particular, an identifier of the required software component and also comprising one or more parameters of the associated software function required in addition to the software component.

According to one example, a VNFD document is a file describing the characteristics of one or more software components (the VNF and its VNFC components, wherein the software component can be the VNF or a VNFC) in terms of the communication network resource requirements and rules for managing the life cycle thereof (instantiation, change of dimension, removal, etc.). In order to be interpretable by management and orchestration systems developed independently of the software components, these descriptors comply with a standard, such as TOSCA or YANG.
This VNFD file provides, in particular, the list of elementary components (VNFC) which, according to this example, make up the software component, and the manner in which they are interconnected. It also indicates, for each elementary component, the number of instances to be deployed at different stages of the life cycle of this software component. For each elementary component, the VNFD file contains an information block known as a VDU (Virtualized Deployment Unit), which precisely describes the communication network resource requirements of the elementary component. These requirements relate to basic resources (CPU, memory, storage, etc.) necessary for the execution of the elementary component software. A software component can therefore correspond to one or more elementary components. One or more of the following parameters can possibly be present in the VNFD file, such as parameters linked to a software function associated with the software component, such as:
number of virtual CPUs, size of the virtual memory, size of a virtual disk, required for the software function,
type of associated software function=FPGA or eBPF,
identification data of the associated software function comprising, for example:
   name of the supplier of the associated software function,
   name of the associated software function to be installed,
   version of the associated software function,
an address for downloading the software function onto the programmable device.
   The VNFD file may be included in a VNF package, wherein the latter may comprise an executable of the associated software function. According to a different example, a link to the executable can be present in the VNFD. The parameter of the associated software function can also correspond to one or more executables of the associated software function, and the characteristic of the programmable device is then obtained depending on one or more of these executables. The programmable device will in fact be determined on the basis of its capacity to support one or more of these executables and, if a plurality of programmable devices are suitable for one executable, i.e. a software program, a different parameter of the software function, such as, for example, its energy consumption, its capacity for processing heavy traffic or its performance/energy consumption ratio will be considered in order to determine a characteristic of the programmable device, such as, for example, its energy consumption, its capacity to process heavy traffic or its performance/energy consumption ratio.

According to one alternative, step E2 can be broken down into a plurality of sub-steps which are not shown. The NFVO can transmit a request to deploy a software component comprising an identifier of the required software component, and, on receiving this request, the VNFM requests the information relating to this software component and to the associated software function from the NFVO if it does not already have this information. The NFVO then transmits the information, for example in a VNFD file corresponding to the identifier, as a second action, i.e. after having received the request therefor from the VNFM. This alternative is useful for systematically limiting the transmission of this information relating to the software component and to the associated software function, and therefore for increasing the traffic on the communication network.

On receiving the identifier of the software component and one or more parameters of the associated software function, in a step E3, the VNFM determines the resource requirements for the deployment of the software component and the software function associated with this software component. In particular, the VNFM characterizes the programmable device suitable for hosting the associated software function by determining a characteristic of the programmable device compatible with the parameters of the associated software function, received in the deployment request. The determination of the programmable device comprises determining characteristics based on the parameters of the software function received from the NFVO.

According to one example, the determination method comprises determining one or more characteristics from the following characteristics:
a memory space size of the programmable device required to host the software function,
a number of processing units of the programmable device required to host the software function,
a type of programmable device required to host the software function,
an identifier of the programmable device required to host the software function,
an address for downloading the software function onto the programmable device.
   It should be noted that one or more parameters of the software function can be included in the characteristics determined in the step of determining the programmable device.

In a step E4, the VNFM transmits an authorization request to the NFVO to deploy the software component comprising a characteristic of a programmable device suitable for hosting the associated software function, determined on the basis of the received parameter. This deployment request transmitted by the NFVO comprises one or more of the characteristics defined in the determination step E3. This information will enable the NFVO to actually ensure that the deployment of the software component will be able to be carried out in a zone where the software function associated with the software component will be able to be installed or else is already installed. The deployment will thus be performed subject to the constraints transmitted in the deployment request.

On the basis of the request to authorize the deployment of the software component and the characteristic(s) of the programmable device required to activate the associated software function, the NFVO then determines, in a step E5, a zone within the communication network comprising a computer server on which the software component can be instantiated, and further comprising a computer server comprising a programmable device compatible with the received characteristic(s). The zone can correspond to a cluster according to one alternative and, according to a different example, the two servers can correspond to the same server hosting the software component and the associated software function. According to a different alternative, the associated software function may already be installed on a programmable device of a server in the zone, in which case it will only remain to instantiate the software component on a server in the same zone as this server. This determination by the NFVO can also be accompanied by the identification of a VIM entity, a virtualized network management entity responsible for managing the virtualized resources of the communication network, for the instantiation of the software component and possibly of the associated software function.

According to a different example, the NFVO determines a zone within the communication network comprising a computer server on which the software component can be instantiated, and further comprising a computer server comprising a programmable device compatible with the characteristic(s) obtained before step E2, and the request sent in step E2 is deemed to be authorized, which means that, according to this example, step E4 in which the VNFM requests an authorization as described above is not required. According to this embodiment, the NFVO obtains, for example from a database, a characteristic of a programmable device suitable for hosting the associated software function, determined on the basis of a parameter of the associated software function.

In an optional step E6, for example if the NFVO has identified a zone and the servers in the zone, the NFVO reserves resources on the second server with a view to deploying the associated software function on the programmable device. This reservation can be made with the VIM entity responsible for managing the virtualized resources of the zone comprising the server. According to a different example, the NFVO can also reserve resources on the first server intended to host the software component.

According to one example, with the contribution of the VIM, the NFVO can install the associated software function on the server on which resources have been reserved in an optional step E7 which is not shown. The NFVO thus transmits to the VIM the computer program of the associated software function intended to update the programmable device of the determined second server. The VIM can thus install the.

According to one example, in a step E8, the NFVO transmits the authorization to deploy the required software component to the VNFM. This authorization includes information relating to the zone in which the server must be selected and possibly an identifier of the first server determined for hosting the virtualized function. The identifier of the first server is not required if all of the servers in the zone can host the software component, given that the zone is selected if it further comprises a computer server comprising a programmable device suitable for hosting the associated software function, regardless of whether said software function is or is not already installed. The identity of the VIM to which the request is to be sent can be transmitted to the VNFM in step E8, particularly if the VIM has been determined in step E5.

In a step E9, the VNFM sends a request to a VIM to deploy the software component in the determined zone by specifying this zone, or by transmitting the identifier of the first server. If no reservation has been made for the installation of the software component in step E6, the VNFM can notify the VIM of the constraints relating to the software component and the associated software function, such that the server selected in the zone for hosting the software component observes the constraints imposed by the associated software function, in accordance with the characteristics determined in step E3. This alternative is useful if the first server determined by the NFVO no longer has the resources necessary for the instantiation of the software component, which may occur, in particular, in the absence of a reservation of resources on the first server. This alternative is also useful if the NFVO entity has not specifically determined a server, but rather a zone comprising the required servers.

In a step E10, the VIM interacts with entities of the communication network in which the software component and the associated software function are deployed in order to create the resources, including, in particular, the virtual machine and the CPU and disk resources, for example, necessary for the instantiation of the software component on the first server in the determined zone.

Once deployed, the software component and the associated software function can interact in a step which is not shown in FIG. 3. According to one example, if the software component relates to a firewall, the software component can transmit rules indicating the types of traffic that are to be managed by the associated software function. According to one example, which is not shown in FIG. 3, the VNFM entity or the VIM entity can transmit to the software component an identifier, such as an address, of a server comprising a programmable device updated with an associated software function relating to the software component, and possibly also security elements enabling the software component to communicate the associated software function in a secure manner.

In a step E11, the VNFM informs the NFVO that the software component has been instantiated and that the associated software function is loaded onto the programmable device of the server, thus informing the NFVO of the availability of the software component and of an operation of this component as required in the service of which the deployment was requested in step E0, i.e. with the assistance of the associated software function.

Reference is now made to FIG. 4, which shows a diagram illustrating the main steps of a determination method according to a second embodiment. In this embodiment, the virtualization technology is based on containers. In this embodiment, the computer servers as shown in the preceding figures are equipped with containers suitable for hosting software components and are, for example, capable of hosting software functions, for example via a network card equipped with an FPGA processor. For the sake of understanding, this figure is deliberately simplified compared with NFV MANO (Network Function Virtualization (NFV) Management and Orchestration) architecture.

Steps E0 to E4 shown in FIG. 4 are comparable with those shown in FIG. 3 and are independent of the type of virtualization implemented in the communication network.

In step E5, the NFVO determines a zone within the communication network comprising a computer server on which the software component can be instantiated and further comprising a computer server comprising a programmable device compatible with the received characteristic(s) of the programmable device. More precisely, the NFVO determines a cluster, also identified as a group of servers, in which one or more physical or virtual servers of the cluster playing the role of CIS are equipped with a programmable device compatible with the associated software function, and one or more physical or virtual servers playing the role of CISM are equipped with a management function of the programmable device on which the associated software function is to be deployed, given that a server of the cluster must also be suitable for instantiating the required software component.

According to one alternative, if no cluster is determined, a new cluster can be created. This new cluster or group of servers comprises at least one server suitable for hosting the software component and a server suitable for comprising a programmable device which can be updated with the associated software function, in accordance with the characteristic received in step E4. This creation is performed through interaction with the VIM, CISM and CCM entities of the system responsible for the orchestration and management of the virtualized infrastructure of the communication network. According to one example, the NFVO informs the OSS in a step E51 that no zone or no existing cluster comprises the two servers required for the software component and the associated software function, wherein this second server must comprise a programmable device in accordance with the characteristics received in step E4.

In a step E52, the OSS determines that a new cluster meeting the requirements as determined must be created. The NFVO can thus transmit the characteristics required for the new cluster in step E51.

In a step E53, the OSS sends a request to the CCM, directly or via the NFVO, particularly if the OSS has not received the characteristics of the new cluster to be created, to create a new cluster in accordance with the characteristics relating to the two servers.

In a step E54, the CCM creates the new cluster and in turn, in a step E55, informs the OSS, possibly via the NFVO, to this effect. This information message relating to the new created cluster further includes the characteristics of the new cluster and possibly the characteristics of two servers suitable for hosting the software component and the associated software function respectively.

If a new cluster is created, in accordance with steps E51 to E55 described above, steps E0 to E5 can be repeated in order to determine the cluster in which the software component and the associated software function can be installed.

According to one example, with the contribution of the CCM, the NFVO, in collaboration with the CCM, can install the associated software function on the programmable device of the second server suitable for the characteristics received in step E4. Thus, in step E6, the NFVO transmits to the CCM the computer program of the associated software function intended to update the programmable device of the determined second server, this update been performed by the CCM and the CISM in step E7, possibly in collaboration with the VIM. The second server comprising the programmable device on which the associated software function is installed is then specifically labeled or identified to locate it during the installation of the software component on the first server.

In a step E8, according to one example, the NFVO transmits the authorization to deploy the required software component to the VNFM. This authorization includes information relating to the cluster in which the server must be selected and, if the associated software function has been installed in accordance with step E7, this authorization further includes information relating to the labeling of the second server, thus enabling the VNFM to select a first server suitable for the software component to be installed and the required interaction between the software component and the associated software function.

In a step E9, the VNFM interacts with the CISM to deploy the software component. If, in step E8, the NFVO has transmitted information relating to the labeling of the second server to be used to select the first server, the VNFM then transmits it to the CISM in step E9. If this information has not been transmitted, the VNFM transmits the required characteristics of the programmable device as determined in step E3 to the CISM, and the CISM then selects one or more servers suitable for hosting the software component and located in the same cluster as the second server comprising the programmable device.

If the associated software function has not been installed, the CISM installs it on the second server determined on the basis of the characteristics, and the CISM possibly interacts with the VIM to create the resources necessary for the installation of the software component in step E10.

Once installed, the software component and the associated software function interact in accordance with the description above relating to FIG. 3.

In a step E11, the CISM informs the NFVO, via the VNFM, that the software component has been instantiated on the first server of the determined cluster, and that the associated software function is installed on the programmable device of the second server of the same cluster, thus informing the NFVO of the availability of the software component and of the functioning of this component as required in the service of which the deployment was requested in step E0.

According to one example, which is not shown in FIG. 4, the VNFM entity or the VIM entity or the CISM entity can transmit to the software component an identifier, such as an address, of a server comprising a programmable device updated with an associated software function relating to the software component, and possibly security elements enabling the software component to request the associated software function.

In the case of a software component implemented in a container, according to the embodiment shown in FIG. 4, the term server that is used refers to a physical server as well as a virtual machine, the container then being instantiated on a virtual machine. In this second case, the CCM interacts with the VIM to install the associated software function on the programmable device of the virtual machine on a server.

The computer programs relating to the associated software function can be obtained by the entity responsible for installing said function via a link, for example a URI (Uniform Resource Identifier), specified, for example, in a VNFD document.

A software component makes use of its own dedicated software function, and these different software functions can be deployed on the same programmable device according to one example. A software component may require a plurality of associated software functions in the embodiments described.

The computer program relating to the associated software function may require compilation before its installation to make it compatible with the programmable device of the second server.

The description of the requirement for an associated software function for a software component can be present in a VNFD file described above, or else in a document specific to the virtualization technology that is used, for example in Helm Charts files if a Kubernetes solution is employed.

If a virtualized function comprising a plurality of elementary components needs to be instantiated, and if the virtualized function or one or more of its components needs to be associated with the software function, the methods described in FIG. 3 and FIG. 4 can be carried out for the virtualized function and/or can be repeated for the different components and their associated software functions. The software component may correspond to either a virtualized function or an elementary component. According to one alternative, the virtualized function represents a software component according to the terminology used in the different embodiments, and the methods described in FIG. 3 and FIG. 4 are carried out once only for all of the elementary components of the virtualized function.

The loading or installation of an associated software function onto a programmable device of a server of a zone or cluster, or even the creation of a cluster, can be carried out prior to step E0, for example in a step of updating the virtualized infrastructure of the communication network, prior to the requirement for an associated software component.

The two embodiments described with reference to FIG. 3 and FIG. 4 can comprise two different servers in a zone or cluster, or a single server in this zone or cluster, this single server hosting one or more software components and one or more associated software functions.

A programmable device is not necessarily hardware. The use of a programmable hardware device represents a family of solutions as mentioned in the description of the context of the invention at the beginning of this description. A different family involves the deployment of programmable software devices. This is the case, for example, for optimizing the packet processing path within the server using software technologies, for example eBPF (Extended Berkeley Packet Filter) or DPDK (Data Plane Development Kit), constituting programmable software devices.

The methods for determining a group of servers and for determining the programmable device described with reference to FIG. 3 and FIG. 4 are relevant, in particular, in open multivendor environments. In fact, the methods serve to characterize the programmable device required for a software function associated with an installed software component, and to ensure that a zone in which a software component is deployed comprises a server having the appropriate programmable device, thus ensuring optimum operation of the software component relieved of certain operations by the associated software function.

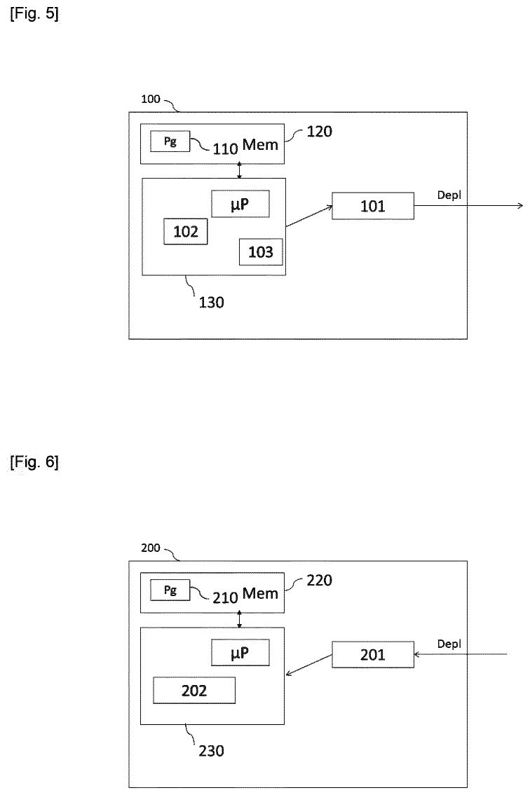

Reference is now made to FIG. 5, which shows a representation of a device for determining a group of servers according to one example.

Such a device for determining a group of servers can be implemented in an orchestration entity, such as an NFVO entity according to NFV terminology, as shown in FIG. 2, FIG. 3 and FIG. 4. This determination device can thus be operated by an entity responsible for the management of the zones of a virtualized infrastructure of a communication network.

The device 100, for example, for determining a group of servers comprises a processing unit 130, equipped, for example, with a microprocessor μP, and controlled by a computer program 110, stored in a memory 120 and carrying out the method for determining a group of servers according to the invention. On initialization, the code instructions of the computer program 110 are, for example, loaded into a RAM memory before being executed by the processor of the processing unit 130. Such a device 100 for determining a group of servers comprises:
a transmitter 101, suitable for transmitting to a management unit of the software component a request Depl to deploy the software component, said request comprising an identifier of the software component and at least one parameter of the associated software function,
an obtention module 102, suitable for obtaining a characteristic of the programmable device suitable for hosting the associated software function, determined on the basis of the at least one parameter,
a determination module 103, suitable for determining said group of servers comprising at least a first server suitable for hosting the software component and a second server comprising said programmable device compatible with said obtained characteristic, for example received in a request to authorize the deployment of the software component.

Reference is now made to FIG. 6, which shows a representation of a device for determining a programmable device according to one example.

Such a device for determining a programmable device can be implemented in a management entity of the software component, such as a virtualized function VNF. According to one example, the management entity is a VNFM entity according to NFV terminology, shown in FIG. 2, FIG. 3 and FIG. 4. This device for determining a programmable device can thus be operated by a unit responsible for managing the virtualized functions of a virtualized infrastructure of a communication network.

The device 200 for determining a programmable device comprises, for example, a processing unit 230, equipped, for example, with a microprocessor μP, and controlled by a computer program 210, stored in a memory 220 and carrying out the method for determining a programmable device according to the invention. On initialization, the code instructions of the computer program 210 are, for example, loaded into a RAM memory before being executed by the processor of the processing unit 230. Such a device 200 for determining a programmable device comprises:
a receiver 201, suitable for receiving, from an orchestration entity, a request Depl to deploy the software component, said request for an identifier of the software component comprising an identifier of the software component and at least one parameter of the associated software function,
a determination module 202, suitable for determining a characteristic of the programmable device suitable for hosting the associated software function depending on the at least one parameter received in the deployment request.

1. A determination method comprising:
determining a group of computer servers of a virtualized communication network, said group being capable of hosting a software component contributing to provision of a service in said network, said software component requiring implementation of an associated software function for processing a service datum, wherein the determining is implemented in an orchestration entity of at least one service in the network and comprises:
transmitting a request to deploy the software component to a management entity managing the software component, said request comprising an identifier of the software component and at least one parameter of the associated software function;
obtaining a characteristic of a programmable device suitable for hosting the associated software function, determined on the basis of the at least one parameter; and
determining said group of servers, comprising at least a first server suitable for hosting the software component and a second server comprising said programmable device compatible with said obtained characteristic.

2. The determination method as claimed in claim 1, in which obtaining the characteristic comprises receiving an authorization request from the software component management entity to deploy the software component.

3. The determination method as claimed in claim 1, further comprising reserving a resource of the second server comprising said programmable device.

4. The determination method as claimed in claim 2, further comprising deploying, by using a management entity of the virtualized communication network, the software function on said programmable device of the second server of which a resource has been reserved.

5. The determination method as claimed in claim 1, further comprising creating a group of servers comprising at least one server suitable for hosting the software component, and a server comprising said programmable device compatible with said characteristic.

6. The determination method as claimed in claim 1, wherein obtaining a characteristic of a programmable device suitable for hosting the associated software function comprises obtaining at least one characteristic of a programmable device included in a group consisting of:
a memory space size of the programmable device,
a number of processing units of the programmable device,
a type of programmable device,
an identifier of the programmable device,
an address for downloading the software function onto the programmable device.

7. The determination method as claimed in claim 1, in which the software function is an acceleration function for processing the data flow.

8. The determination method as claimed in claim 1, further comprising transmitting, to a management entity of the virtualized network, a computer program of the associated software function intended to update the programmable device of the second server.

9. The determination method as claimed in claim 1, in which the request to deploy comprises transmitting a document comprising the identifier of the software component and the at least one parameter of the associated software function, said document further comprising a reference to the associated software function and a reference to a computer program, on the basis of which the associated software function is made compatible with the programmable device.

10. A determination method comprising:
determining a programmable device capable of hosting a software function associated with a software component contributing to provision of a service in a virtualized communication network, said programmable device being implemented in a server of the network, the determining being carried out in a management entity for the software component in at least one service of the network and comprising:
receiving, from an orchestration entity, a request to deploy the software component, said request comprising an identifier of the software component and at least one parameter of the associated software function; and
determining a characteristic of the programmable device suitable for hosting the associated software function on the basis of the at least one parameter received in the deployment request.

11. The determination method as claimed in claim 10, further comprising transmitting an authorization request to the orchestration entity to deploy the software component comprising the determined characteristic.

12. The determination method as claimed in claim 10, further comprising, prior to the determining, transmitting a request for a document describing the software component and receiving said document.

13. The determination method as claimed in claim 10, further comprising receiving a message requesting installation of the software component on a first server of a group of servers and requesting installation of the software function on a programmable device comprised in a second server of the group of servers, said programmable device being compatible with said determined characteristic.

14. The determination method as claimed in claim 10, further comprising transmitting a message requesting deployment of the software component on the first server of said determined group.

15. A device comprising:
at least one processor; and
at least one non-transitory computer readable medium comprising instructions stored thereon which when executed by the at least one processor configure the device to determine a group of computer servers of a virtualized communication network, said group being capable of hosting a software component contributing to provision of a service in said network, said software component requiring implementation of an associated software function for processing a service datum, wherein the determining comprises:
transmitting a request to a management entity of the software component to deploy the software component, said request comprising an identifier of the software component at least one parameter of the associated software function;
obtaining a characteristic of a programmable device suitable for hosting the associated software function, determined on the basis of the at least one parameter; and
determining said group of servers comprising at least a first server suitable for hosting the software component, and a second server comprising said programmable device compatible with said obtained characteristic.

16. A device comprising:
at least one processor; and
at least one non-transitory computer readable medium comprising instructions stored thereon which when executed by the at least one processor configure the device to determine a programmable device capable of hosting a software function associated with a software component contributing to provision of a service in a virtualized communication network, said programmable device being implemented in a server of the network, wherein the determining comprises:
receiving a request from an orchestration entity to deploy the software component, said request for an identifier of the software component comprising an identifier of the software component and at least one parameter of the associated software function; and
determining a characteristic of the programmable device suitable for hosting the associated software function on the basis of the at least one obtained parameter.

17.

18. A non-transitory computer readable medium comprising a computer program product stored thereon comprising a set of program code instructions which, when executed by at least one processor, configure said at least one processor to carry out the method for determining the group of servers as claimed in claim 1.

19. A non-transitory computer readable medium comprising a computer program product stored thereon comprising a set of program code instructions which, when executed by at least one processor, configure said at least one processor to carry out the method for determining the programmable device as claimed in claim 10.
